(19) United States
(12) Patent Application Publication
(10) Pub. No.: US 2007/0097990 A1
(43) Pub. Date: May 3, 2007

(54) Communication control method

(75) Inventors: Takahiro Ozaki, Tokyo (JP); Shuichi Sato, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/589,957

(22) Filed: Oct. 31, 2006

(30) Foreign Application Priority Data
Oct. 31, 2005 (JP) P2005-316379

(51) Int. Cl. H04L 12/56

(52) U.S. Cl. 370/395.52

(57) ABSTRACT

According to one embodiment, a communication control method of a communication system which connects an IP network to plural networks including IP communication devices through routers provided for respective networks, which communicates between the IP communication devices of the different networks through the IP network with IP-packetized data, and which contains plural relay servers including a first and second relay servers, the method includes: determining whether peer-to-peer communication between the IP communication devices can be conducted by using a test packet through the first and second relay servers and the router; relaying the IP packet by the first or second relay server between the IP communication devices determined that the peer-to-peer communication cannot be conducted; and sequentially switching a relay server to relay the IP packet according to a state of the first relay server, from the first relay server to a relay server other than the first relay server.

### CROSS-REFERENCE TO RELATED APPLICATIONS

This application is based upon and claims the benefit of priority from Japanese Patent Application No. 2005-316379, filed on Oct. 31, 2005, the entire contents of which are incorporated herein by reference.

### BACKGROUND

1. Field

One embodiment of the invention relates to a communication control method in a communication system for conducting information communication through an IP (Internet Protocol) network and including a router having a conversion function of a private address and a global address.

2. Description of the Related Art

In recent years, a system in which IP-packetized data such as voice, video, a modem, a fax, etc. is transmitted through an IP network has been widely constructed. In the IP network, a router is a key device. The router transfers an IP packet based on a destination address and a source address.

This kind of communication system can be constructed by plural networks through the routers. In such a system, terminals between different networks may be unable to conduct peer-to-peer communication depending on a function of the router. That is, there is a router has a conversion function of a private address and a global address. This kind of router is called a NAT (Network Address Translator) router and is often provided for effective utilization of an IP address. Because of this conversion function, a discrepancy between a source address and a destination address occurs inside the network, and the communication may be restricted from a security aspect.

In order to prepare for such circumstances,. it is contemplated to provide a relay server of an IP packet and deliver the IP packet between terminals through this relay server. However, in this technique, a load on the relay server is increased together with an increase in traffic between the terminals, so that it may be difficult to cope with demand for sudden traffic in recent years. Also, allocation of the relay server is fixed, so that when a relay function goes down, for example, at the time of maintenance replacement work or at the time of failure of the relay server, and communication between different networks cannot be conducted.

In Japanese Patent Application Publication (Kokai) No. 2005-57388, an IP communication method is disclosed. In this method, an address response server is provided. A packet with IP description of a terminal is sent to the address response server. An address conversion server notifies a response source terminal of a port and a source IP address of the packet received and thereby an address converted by a NAT router can be obtained. Accordingly, direct communication between the terminals can be conducted by obtaining the address converted by the NAT router, but it is necessary to newly provide the address response server in the system.

In Japanese Patent Application Publication (Kokai) No. 2005-57388, an address solution method is disclosed. In the method, outgoing and incoming from another network to a terminal is performed without having a global IP address. In the case of establishing a signal path for call control in the range on a private network, a thread for controlling both the terminals by an address resolution server having a global address is created. An inquiry is made from a VoIP (Voice over IP) server for managing identification information sent from the terminal. A call control signal and a voice signal are relayed between threads for processing the range between terminals for making a call. However, it is necessary to establish signal paths between the address resolution server and all the terminals previously and also peer-to-peer communication between the terminals cannot be conducted.

As described above, when a NAT router is provided in a communication system through an IP network, the NAT router may restrict communication between terminals on different networks. In order to prepare for such circumstances, provision of a relay server is carried out, but a load on the relay server is increased together with an increase in traffic. Communication between different networks cannot be conducted depend on states of the relay server, for example, at the time of maintenance replacement work or at the time of failure of the relay server.

### BRIEF DESCRIPTION OF THE SEVERAL VIES OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a communication system according to an embodiment of the invention;

FIG. 2 is an exemplary diagram showing a function of a router;

FIG. 3 is an exemplary sequence diagram showing communication enabling determination processing according to the embodiment;

FIG. 4 is an exemplary sequence diagram showing a processing procedure of the case where a router does not pass a packet from another terminal according to the embodiment;

FIG. 5 is an exemplary diagram showing one example of a management table of communication enabling or disabling according to the embodiment;

FIG. 6 is an exemplary sequence diagram showing a communication procedure between terminals of the case of a communication enabling NG according to the embodiment;

FIG. 7 is an exemplary sequence diagram showing a switching procedure of a relay server according to the embodiment;

FIG. 8 is an exemplary diagram showing one example of a management table for managing priority of a relay server used as a destination of a connection test packet stored in each of the IP communication devices according to the embodiment; and

FIG. 9 is an exemplary diagram showing one example of a management table for managing priority of a test relay server stored in each of the relay servers 1b, 2b, 3b according to the embodiment.

### DETAILED DESCRIPTION

Various embodiments according to the invention will be described hereinafter with reference to the-accompanying drawings.

In general, according to one embodiment of the invention, a communication control method of a communication system which connects an IP network to plural networks including IP communication devices through routers provided for respective networks, which communicates between the IP communication devices of the different networks through the IP network with IP-packetized data, and which contains plural relay servers including a first relay server and a second relay server which relay the IP packet and a control signal to which a global IP address is assigned, the method includes: determining whether peer-to-peer communication between the IP communication devices can be conducted by using a test packet through the first and second relay servers and the router; relaying the IP packet by the first or second relay server between the IP communication devices determined that the peer-to-peer communication cannot be conducted; and sequentially switching a relay server to relay the IP packet according to a state of the first relay server, from the first relay server to a relay server other than the first relay server.

As described above, according to one embodiment of the invention, relay processing is sequentially switched and performed by other relay servers according to a state of a relay server. As a result of this, the relay processing is distributed to plural relay servers and a load can be prevented from concentrating on the particular relay server. Further, communication between the IP communication devices can be ensured by switching the relay processing to other relay servers even at the time of maintenance replacement work or at the time of failure of the relay server. Accordingly, there is provided a communication control method capable of preventing a load from concentrating on a particular relay server and also preventing a relay function from going down.

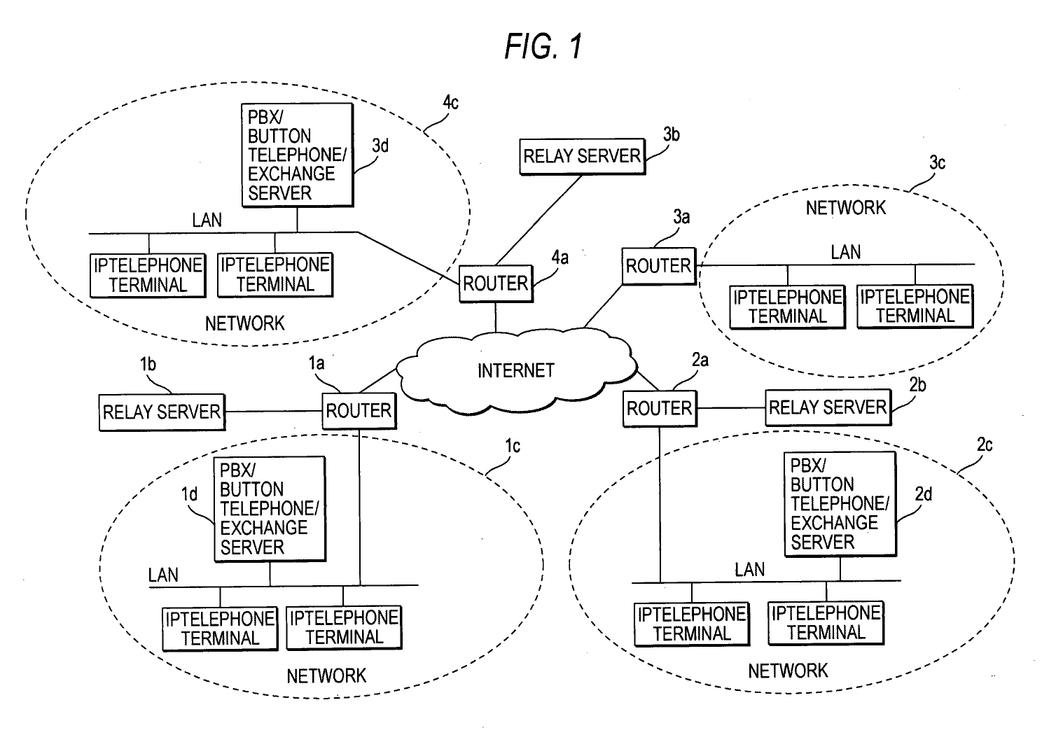

FIG. 1 is an exemplary block diagram showing a communication system according to an embodiment of the invention. In FIG. 1, mutually different networks 1c, 2c, 3c, 4c are connected to the Internet through routers 1a, 2a, 3a, 4a, respectively. The network 1c includes plural IP telephone terminals disposed on a LAN (Local Area Network) and a PBX(Private Branch eXchanger)/button telephone/exchange server 1d for offering exchange service in an IP to these terminals. The network 2c similarly includes plural IP telephone terminals disposed on a LAN and a PBX/button telephone/exchange server 2d. The network 3c includes only plural IP telephone terminals, but these IP telephone terminals conduct voice communication using the PBX/button telephone/exchange server 1d on the network 1c or the PBX/button telephone/exchange server 2d on the network 2c. The network 4c comprises plural IP telephone terminals disposed on a LAN and a PBX/button telephone/exchange server 3d for offering exchange service in an IP to these terminals in a manner similar to the networks 1c, 2c. The system includes relay servers 1b, 2bconnected to the networks 1c, 2c, 3c and Internet through the routers 1a, 2a. The relay servers 1b, 2b relay the IP packetized data and a control signal to which a global IP address is assigned. In the system, the IP communication devices are communicated through different communication channels for the control signal and the IP-packetized data.

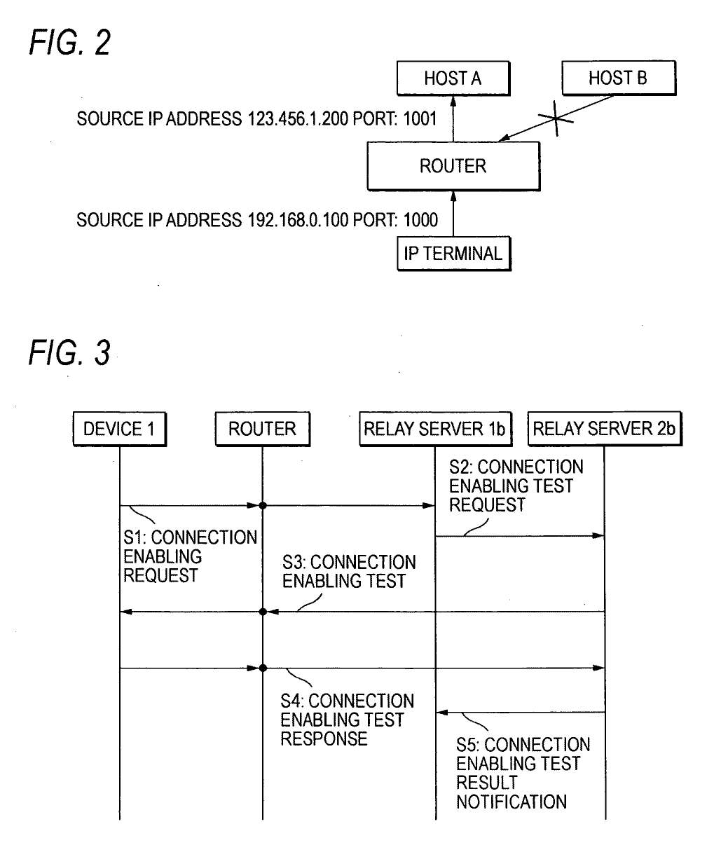

The system of FIG. 1 thus takes the form in which plural networks are connected to the IP network through the routers. In such a configuration, it may become impossible to conduct communication between terminals of different networks depending on functions of, for example, the routers 1a, 2a. This situation will be described using FIG. 2.

FIG. 2 is an exemplary diagram showing a function of a router. In the case of a communication system includes plural networks as shown in FIG. 2, when the router has a NAT function in the case of communicating from an IP terminal to a host A, a source IP address of the IP terminal may be converted at the router and the converted IP address may be sent to the Internet. For example, it is assumed that the source IP address: 192.168.0.100 and Port No.: 1000 of the IP terminal is converted into IP address: 123.456.1.200 and Port No.: 1001. Then, a router may have a function to restrict access from a device other than the host A (a host B etc.) to the IP address 123.456.1.200 and Port No.: 1001. In this case, there are cases where IP data of voice, video, a fax, a modem, etc. cannot be communicated between the IP terminal of the inside of the network 1c and the IP terminal of the inside of the network 2c in a peer-to-peer manner.

FIG. 3 is an exemplary sequence diagram showing communication enabling determination processing according to the embodiment. The IP communication device 1, such as the PBX/button telephone/exchange server 1d or the IP terminal (e.g., the IP telephone terminal) on the network 1c activates communication enabling determination processing in order to determine whether or not peer-to-peer communication with a terminal on another network can be conducted after a power source is turned on or an error of communication with a relay server occurs.

The IP communication device 1 sends a connection enabling request by a UDP (User Datagram Protocol) packet to a relay server (for example, a relay server 1b) registered previously. This connection enabling request is received by the relay server 1b with the address converted by the router 1a (S1). An IP address of the IP communication device 1 is described in this connection enabling request.

The relay server 1b receives the connection enabling request, and then describes a source IP address and a port number of the UDP packet described in a header thereof in a connection enabling test request for testing enabling or disabling of connection. The relay server 1b sends the connection enabling test request to a relay server 2b having a global IP address (S2). The relay server 2b receives the connection enabling test request, and then sends the UDP packet toward the IP address and the port number described in the connection enabling test request (S3).

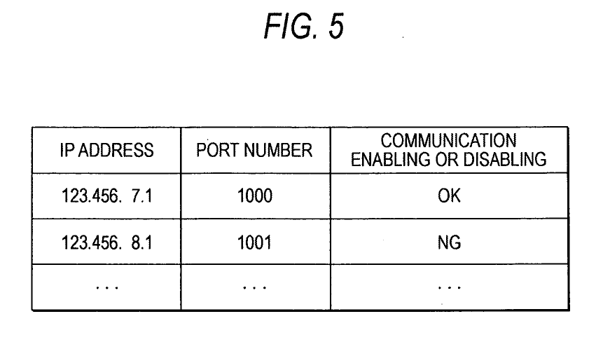

When the router 1a passes an IP packet from a device other than the relay server 1bto which the IP communication device 1 sends the UDP packet, a connection enabling test packet sent from the relay server 2b reaches the IP communication device 1. Hence, the IP communication device 1 receives the connection enabling test packet from the relay server 2b, and then sends a connection enabling test response indicating a result OK to the relay server 2b. The relay server 2b receives this connection enabling test response, and then describes an IP address and a port number with a communication enabling OK in a management table as shown in FIG. 5 (S4).

The relay server 1b receives notification of the connection enabling test response from the relay server 2b, and then describes the IP address, the port number and the communication enabling OK in the management table of FIG. 5 (S5). In addition, from the second time or later, at a point in time of receiving a connection enabling request from the IP communication device, the management table of FIG. 5 is retrieved and when a request from the same IP address and the port number has already been processed, the processing of S2 or later is not performed.

Also, in the relay server 1b, when an IP address of a UDP header of a connection enabling request sent from the IP communication device matches with an IP address described in a connection enabling request sent from the IP communication device, address conversion is not made by a NAT router, so that the procedure of S2 or later is not performed.

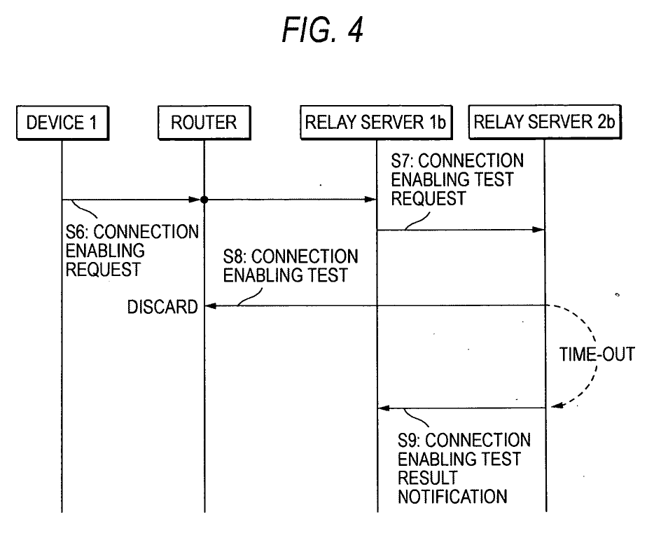

FIG. 4 is an exemplary sequence diagram showing a processing procedure of the case where a router does not pass a packet from another terminal according to the embodiment. In FIG. 4, processing to S6 and S7 is similar to S1 and S2. When a relay server 2b sends a connection enabling test packet to an IP terminal device 1 (S8), a timer is set. The relay server 2b detects that the connection enabling test packet is discarded in a router 1a by time-out of the timer. Then, the relay server 2b describes an IP address and a communication enabling NG in the management table of FIG. 5 and sends connection test result notification to a relay server 1b (S9). The relay server 1b receives the connection test result notification, and then describes the IP address, a port number and the communication enabling NG in the management table of FIG. 5.

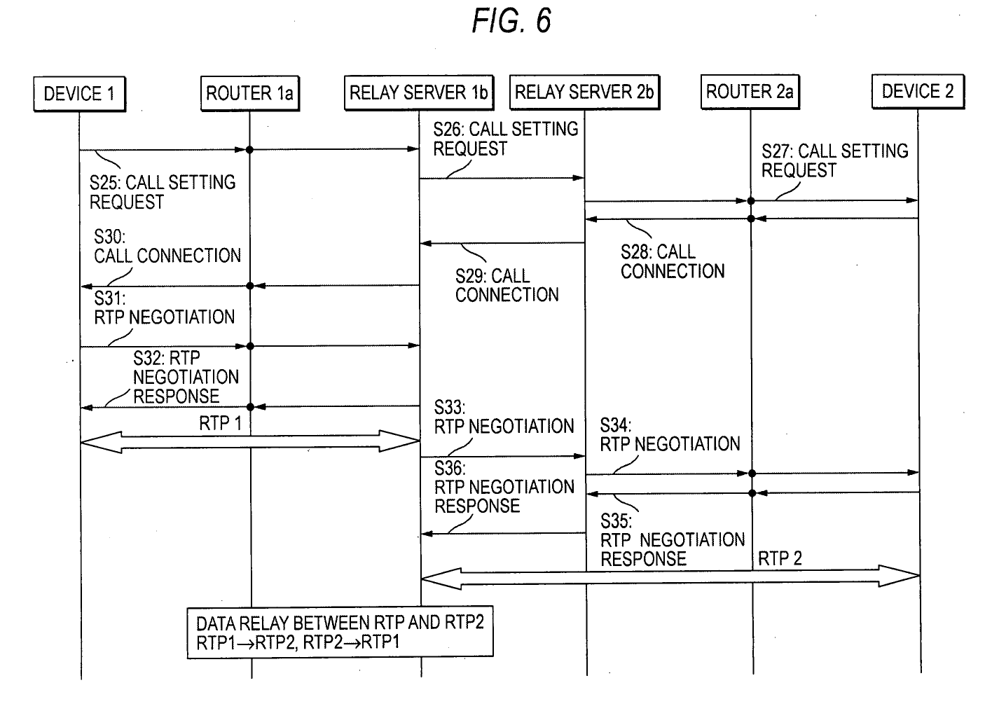

FIG. 6 is an exemplary sequence diagram showing a communication procedure between terminals of the case of a communication enabling NG according to the embodiment. In this sequence, a signal between IP communication devices is relayed by a relay server. Signals from S25 to S30 are a procedure to make a peer-to-peer call between terminals, and the procedure can also be performed by a standard procedure such as Megaco, H.323 or SIP (Session Initiation Protocol).

In FIG. 6, a call setting request which is an outgoing request from an IP communication device 1 is relayed by a router 1a, a relay server 1b, a relay server 2b and a router 2a and is received by an IP communication device 2 (opposite destination terminal) (S25 to S27). When the IP communication device 2 answers, call connection notification is relayed by the router 2a, the relay server 2b, the relay server 1b and the router 1a and is received by the IP communication device 1 (S28 to S30). After receiving this, the IP communication device 1 sends an RTP negotiation request to the relay server 1b of negotiation of an RTP (Real-time Transport Protocol) (S31).

Next, the relay server 1b sends an RTP negotiation response to the IP communication device 1 and RTP connection between the relay server 1b and the IP communication device 1 is made (S32). The relay server 1b, in which the RTP is established between the relay server 1b and the IP communication device 1, sends an RTP negotiation request to the relay server 2b in order to establish an RTP between this relay server 1b and the IP communication device 2 (S33).

The relay server 2b relays the RTP negotiation request sent from the relay server 1b to the IP communication device 2 (S34). The IP communication device 2 receives this RTP negotiation request, and sends an RTP negotiation response to the relay server 1b (S35, S36). Then, an RTP is established between the relay server 1b and the IP communication device 2. In addition, in the procedure described above, a standard procedure such as SDP (Session Description Protocol) can also be used as the RTP negotiation request.

In FIG. 6, when the relay server 1b determines that the router 1a or the router 2a does not permit access from another device in accordance with the management table of FIG. 5, and sends voice/video data, fax and modem data sent from the IP communication device 1 through an RTP1 to the IP communication device 2 through an RTP2. Also, the relay server 1b sends voice/video data, fax and modem data sent from the IP communication device 2 through the RTP2 to the IP communication device 1 through the RTP1. Thus, the relay server 1b relays a signal between the IP communication device 1 and the IP communication device 2 and thereby, communication between the IP communication device 1 and the IP communication device 2 can be conducted.

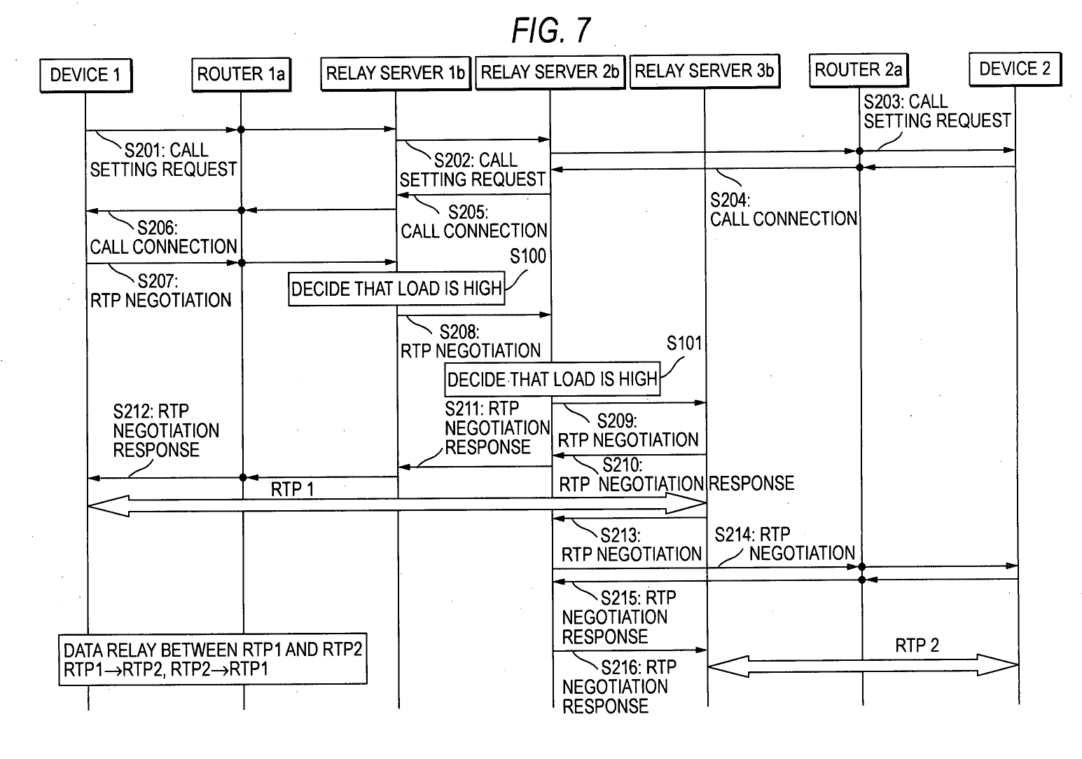

FIG. 7 is an exemplary sequence diagram showing a switching procedure of a relay server according to the embodiment. In FIG. 7, a procedure from S201 to S207 is similar to the procedure from S25 to S31 of FIG. 6. When the processing to here is completed, a relay server 1b checks a self load state. Here, the load state is checked with reference to the number of possible relays caused by call setting (calculated from the number of test result NGs of the management table of FIG. 5), and/or the number of IP communication devices relayed at the present point in time, etc. As a result of that, in the case of deciding that a load on the relay server 1b itself is high (S100), the relay server 1b does not respond to an RTP negotiation request (S207) from an IP communication device 1 and relays this request to a relay server 2b (S208).

The relay server 2b receives the RTP negotiation request similarly, and checks a self load state and in the case of deciding that a load is high (S101), the relay server 2b further relays the RTP negotiation request to a relay server 3b (S209). The relay server 3b receives the RTP negotiation request, and sends an RTP negotiation response to the IP communication device 1 through the relay server 2b in the case of having ability to perform relay processing. As a result of this, connection of an RTP (called an RTP1) is established between the relay server 3b and the IP communication device 1 (S210 to S212).

When the RTP1 is established, the relay server 3b also sends an RTP negotiation request toward an IP communication device 2 through the relay server 2b in order to establish an RTP between the relay server 3b and the IP communication device 2 (S213, S214). The IP communication device 2 receives the RTP negotiation request, and returns an RTP negotiation response toward the relay server 3b through the relay server 2b (S215, S216). As a result of this, an RTP (called an RTP2) is also established between the relay server 3b and the IP communication device 2.

The relay server 3b sends voice/video data, fax and modem data sent from the IP communication device 1 through the RTP1 to the IP communication device 2 through the RTP2. Also, the relay server 3b sends voice/video data, fax and modem data sent from the IP communication device 2 through the RTP2 to the IP communication device 1 through the RTP1. Thus, the relay server 3b relays a signal between the IP communication device 1 and the IP communication device 2 and thereby, communication between the IP communication device 1 and the IP communication device 2 can be conducted.

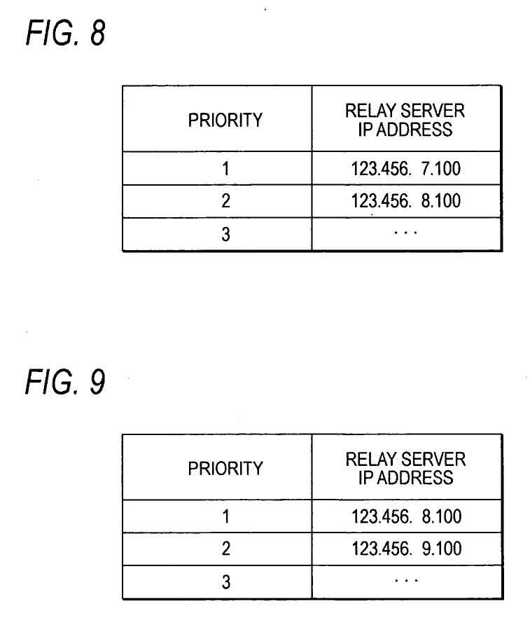

In addition, in this embodiment, an IP address of a relay server used as a notification destination of a connection enabling test packet is previously stored in each of the IP communication devices, respectively. Plural addresses of the relay servers are set every IP communication device, and priority is assigned to each of the relay servers. Management of the IP addresses and priorities is performed by a management table as shown in FIG. 8.

When an error of communication with the highest-priority relay server occurs, the IP communication device sequentially switches a destination of the connection enabling test packet to the relay server with lower priority. As a result of this, a communication path of the IP communication device is ensured by going through another relay server of the inside of the system even when the relay server cannot be used due to failure or maintenance operation work.

Similarly, the IP communication device may switch a destination of the call connection or the data communication to the relay server with lower priority. For example, the IP communication device starts a timer at a time of sending the RTP negotiation request (e.g., S207 in FIG. 7). When an error of communication with the highest-priority relay server occurs, the IP communication device does not receive the RTP negotiation response (e.g., S212 in FIG. 7) from the relay server. In case of predetermined time has passed from sending the RTP negotiation request, the IP communication device sequentially switches a destination of RTP negotiation request to the relay server with lower priority.

As a result, a communication path of the IP communication device is ensured by going through another relay server of the inside of the system even when the relay server cannot be used due to failure or maintenance operation work. The error of communication with the relay server includes the internal error of the relay server caused by failure or maintenance operation work, the error in the communication path between the IP communication device the relay server, etc. For switching the relay server at call connection or the data communication, different management table than the management table for a connection test packet as shown in FIG. 8 may be prepared, but the same management table for the connection test packet may be used.

Also, in this embodiment, an IP address of a relay server (a test relay server) used as a destination of a connection enabling test packet is previously stored in each of the relay servers 1b, 2b, 3b, respectively. A plurality of the test relay servers are set at every relay server 1b, 2b, 3b and priority is assigned to each of the test relay servers. Management of the test servers and priorities is performed by a management table as shown in FIG. 9. The management table of FIG. 9 is stored in, for example, the relay server 1b and a relay server with the first priority is, for example, the relay server 2b and a relay server with the second priority is, for example, the relay server 3b . Of course, the contents of the management table of FIG. 9 may vary every relay server.

Each of the relay servers selects a destination of a connection enabling test packet in order of decreasing priority of the management table of FIG. 9. A relay server with the highest priority becomes a test relay server by default. When the test relay server by default cannot be used due to failure or maintenance operation work, the connection enabling test packet is sequentially sent to the test relay server with lower priority. By such processing, a connection enabling test can be made by switching to another relay server of the inside of the system even when the test relay server cannot be used due to failure or maintenance operation work.

Similarly, the relay server may switch a destination of the call connection or the data communication to the relay server with lower priority. For example, the relay server starts a timer at a time of sending the RTP negotiation request (e.g., S208 or S209 in FIG. 7). When an error of communication with the highest-priority relay server occurs, the relay server does not receive the RTP negotiation response (e.g., S212 in FIG. 7) from the destination relay server. In case of predetermined time has passed from sending the RTP negotiation request, the relay server sequentially switches a destination of RTP negotiation request to the relay server with lower priority.

The RTP negotiation can be made by switching to another relay server of the inside of the system even when the test relay server cannot be used due to failure or maintenance operation work. For switching the relay server at call connection or the data communication, different management table than the management table for a connection test packet as shown in FIG. 9 may be prepared, but the same management table for the connection test packet may be used.

In this embodiment as described above, in the case of configuring a voice/video communication system by connecting plural different networks through routers in the voice/video communication system using an IP, plural relay servers 1b, 2b, 3b for relaying voice/video/fax/modem data and a call control signal to which a global IP address is assigned are prepared. Then, a state of every relay server 1b, 2b, 3b is checked at the time of call connection. The checked state includes load state of the relay server, and/or the communication state with the relay server, etc. In the case of determining that the checked state is the predetermined state (e.g., a load is high), relay processing is shifted to a test relay server or other relay servers. As a result of this, a load does not concentrate on one relay server when the relay server relays voice/video data, fax and modem data between IP communication devices.

That is, a load can be prevented from concentrating on the particular relay server by distributing relay processing to plural relay servers when peer-to-peer communication between terminals on different networks cannot be conducted depending on a function of a router and a relay server relays a voice/video packet sent and received between the terminals in a communication system for connecting different networks to an IP network through routers and comprising plural relay servers for relaying communication between the networks.

Also, communication between terminals on different networks can be conducted even at the time of maintenance replacement work or at the time of failure of a relay server by presetting addresses of plural relay servers to an IP communication device. Further, a connection enabling test can be made even at the time of maintenance replacement work or at the time of failure of a test relay server by presetting addresses of plural test relay servers to a relay server. From these, there is provided a communication control method capable of preventing a load from concentrating on a particular relay server and also preventing a relay function from going down.

It is to be understood that the present invention is not limited to the specific embodiment described above and that the invention can be embodied with the elements modified without departing from the spirit and scope of the invention. The present invention can be embodied in various forms according to appropriate combinations of the elements disclosed in the embodiment described above. For example, some elements may be deleted from all elements shown in the embodiment. Further, the elements in different embodiments may be used appropriately in combination.

What is claimed is:

1. A communication control method of a communication system which connects an IP network to plural networks including IP communication devices through routers provided for respective networks, which communicates between the IP communication devices of the different networks through the IP network with IP-packetized data, and which contains plural relay servers including a first relay server and a second relay server which relay the IP packet and a control signal to which a global IP address is assigned, the method comprising:
determining whether peer-to-peer communication between the IP communication devices can be conducted by using a test packet through the first and second relay servers and the router;
relaying the IP packet by the first or second relay server between the IP communication devices determined that the peer-to-peer communication cannot be conducted; and
sequentially switching a relay server to relay the IP packet according to a state of the first relay server, from the first relay server to a relay server other than the first relay server.

2. The communication control method according to claim 1, wherein the IP communication devices previously store plural IP addresses of relay servers respectively associated with the priorities, to notify a self IP address by using the test packet.

3. The communication control method according to claim 2, wherein, when communication with the first relay server cannot be conducted, the IP communication device performs connection processing sequentially from a relay server with higher priority among the stored IP addresses.

4. The communication control method according to claim 1, wherein the first relay server previously stores plural IP addresses of relay servers, respectively associated with the priorities, used as a switching destination.

5. The communication control method according to claim 4, wherein, when communication with the second relay server cannot be conducted, the first relay server performs connection processing sequentially from a relay server with higher priority among the stored IP addresses.

6. The communication control method according to claim 1, wherein the state of the first relay server includes a load on the first relay server.

7. The communication control method according to claim 1, wherein the state of the first relay server includes a communication state of the first relay server.

8. The communication control method according to claim 1, wherein the IP communication devices are communicated through different communication channels for the control signal and the IP-packetized data.
